(19) United States
(12) Patent Application Publication
(10) Pub. No.: US 2026/0027814 A1
(43) Pub. Date: Jan. 29, 2026

(54) TEXTILE FABRIC

(71) Applicant: JHIH HUEI TRADING CO., LTD., CHANGHUA COUNTY (TW)

(72) Inventor: YUNG-YU WU, Changhua County (TW)

(21) Appl. No.: 18/783,798

(22) Filed: Jul. 25, 2024

(51) Int. Cl. B32B 27/12; B32B 3/26; B32B 3/30; B32B 5/02; B32B 27/30; B32B 27/40; D02G 3/32

(52) U.S. Cl. CPC B32B 27/12; B32B 3/266; B32B 3/30; B32B 5/02; B32B 27/304; B32B 27/40; D02G 3/32; B32B 2307/724; B32B 2307/7265; B32B 2307/7376

(57) ABSTRACT

A textile fabric is provided, including: a main body and at least one membrane. The main body includes two surfaces opposite to each other, and each of the two surfaces has a surface texture being concave and convex. The at least one membrane is coveringly partially disposed on one of the two surfaces and is concave and convex according to the surface texture. Therefore, the at least one membrane has an appearance corresponding to the weaving pattern, and the woven textile has good toughness, is waterproof and is not easily damaged, which solves the problems of a conventional woven textile such as insufficient structural strength and poor durability.

### BACKGROUND OF THE INVENTION

### Field of the Invention

The present invention relates to a textile fabric.

### Description of the Prior Art

Textile fabrics are made of a plurality of yarns by different techniques such as knitting and weaving, and they are widely used in daily life including clothing, shoes, bags, etc. To achieve waterproof and toughening effects, surfaces of the textile fabrics may be coated with a waterproof coating, or the plurality of yarns may be covered with a waterproof coating before weaving.

However, the meshes of the textile fabric may be covered by the waterproof coating on the surfaces, which results in poor softness and poor appearance of the textile fabric, and easy peeling of the waterproof coating. The plurality of yarns with the waterproof coating may have poor flexibility and high frictional resistance, which is inconvenient to weaving and provides poor tactile feel of the textile fabric. In addition, when the meshes of the textile fabrics are large, the textile fabric made by the plurality of yarns with the waterproof coating still cannot achieve waterproof effect. The processing methods as described above cannot be applied locally to the textile fabric so that the elasticity of the whole textile fabric is decreased after processing.

The present invention is, therefore, arisen to obviate or at least mitigate the above-mentioned disadvantages.

### SUMMARY OF THE INVENTION

The main object of the present invention is to provide a textile fabric, which has good toughness and flexibility and preferable appearance.

To achieve the above and other objects, the present invention provides a textile fabric, including: a main body and at least one film layer. The main body includes two surfaces opposite to each other, and each of the two surfaces has a surface texture being concave and convex. The at least one film layer is partially disposed on one of the two surfaces and is concave and convex corresponding to the surface texture.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial cross-sectional view of FIG. 1; and

FIG. 3 is a partial cross-sectional view of a preferable embodiment of the present invention.

### DETAILED DESCRIPTION OF THE PREFERRED EMBODIMENTS

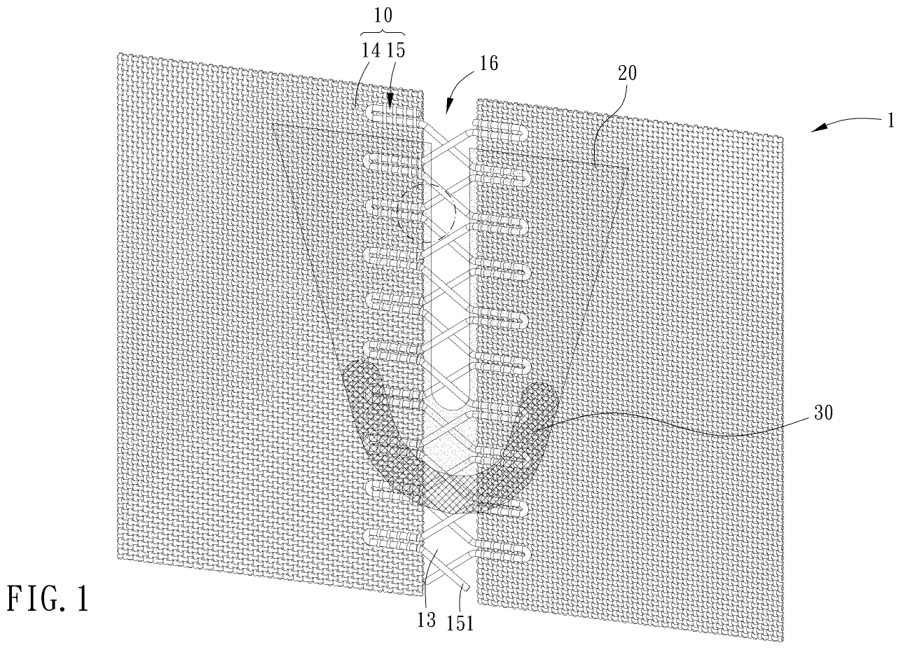

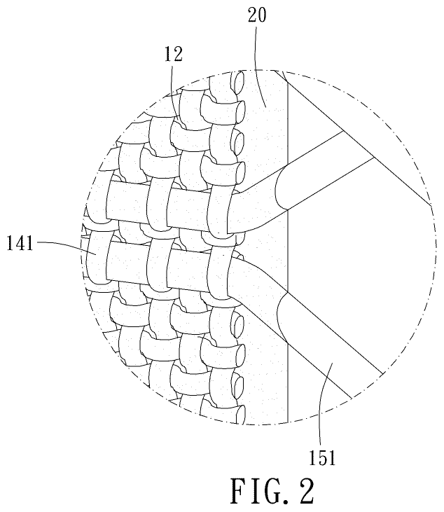

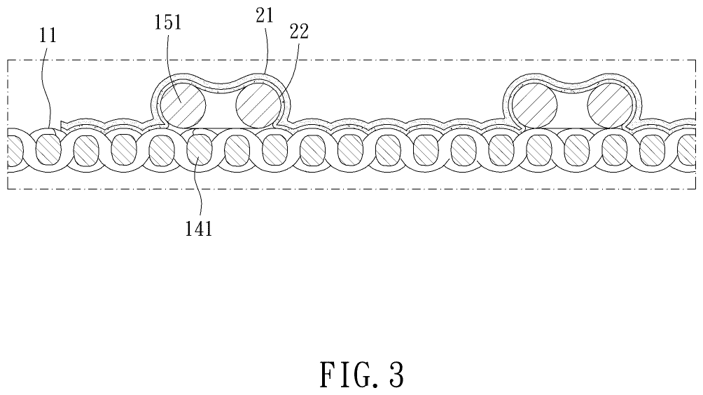

Please refer to FIGS. 1 to 3 for a preferable embodiment of the present invention. A textile fabric 1 of the present invention includes a main body 10 and at least one film layer 20.

The main body 10 includes two surfaces 11 opposite to each other, and each of the two surfaces 11 has a surface texture being concave and convex. The at least one film layer 20 is partially disposed on one of the two surfaces 11 and is concave and convex corresponding to the surface texture. Therefore, the at least one film layer 20 has an appearance corresponding to the surface texture, and the textile fabric 1 has good toughness and is at least partially waterproof and not easy to damage.

The at least one film layer 20 is made of a material including at least one of polyurethane and polyvinyl chloride; and a thickness of each of the at least one film layer 20 is between 20 μm and 450 μm so as to improve a structural strength of the textile fabric and maintain sufficient flexibility of the textile fabric 1. In addition, the at least one film layer 20 can be stably connected with the main body 10 and not easy to peel-off. In this embodiment, the at least one film layer 20 is made of a material including polyurethane and is a waterproof breathable membrane, which has advantages of good wear resistance, toughness and environmental friendly. The thickness of each of the at least one film layer 20 is between 50 μm and 400 μm.

Preferably, each of the at least one film layer 20 includes a film material layer 21 and a connecting layer 22, and the connecting layer 22 is disposed on a side of the film material layer 21 and connected with one of the two surfaces 11. A thickness of the connecting layer 22 is smaller than or equal to a thickness of the film material layer 21, which facilitates combinations of the at least one film layer 20 and the main body 10. A material of the connecting layer 22 is preferably different from a material of the film material layer 21. For example, the film material layer 21 may be made of thermoplastic polyurethane, and the connecting layer 22 may be made of a material that has preferable bonding strength with the main body 10 for stable connection. The film material layer 21 is preferably integrated with the connecting layer 22 in advance. For example, the connecting layer 22 may be partially or completely pre-coated, spayed or filmed on a side of the film material layer 21 so that the at least one film layer 20 can be cut to a predetermined shape and then be disposed on one of the two surfaces 11, which is convenient to be used during processing.

The main body 10 includes a plurality of first through holes 12 and a plurality of second through holes 13, and a diametrical dimension of each of the plurality of second through holes 13 is larger than a diametrical dimension of each of the plurality of first through holes 12. The at least one film layer 20 covers a portion of the plurality of first through holes 12 and a portion of the plurality of second through holes 13. Specifically, the diametrical dimension of each of the plurality of the first through holes 12 is smaller than or equal to 2 mm, and the diametrical dimension of each of the plurality of second through holes 13 is larger than or equal to 5 mm, which allows the at least one film layer 20 to form recessions of varying depths or areas. The at least one film layer 20 is coveringly disposed on one of the two surfaces 11 and exposed outward from the other of the two surfaces 11, which stably restricts a structure of the main body 10 and increase a tensile strength of the main body 10 to avoid deformation. A color of each of the at least one film layer 20 may be different from the main body 10, and may be transparent or translucent, which is selectable according requirements to create special visual effects.

Moreover, the main body 10 further includes at least one first portion 14 and at least one second portion 15, and each of the at least one second portion 15 is connected with the at least one first portion 14. When being stretched by the same force, an amount of deformation of the at least one first portion 14 is smaller than an amount of deformation of the at least one second portion 15 so as to meet various design requirements. The at least one first portion 14 includes a plurality of first yarns 141, the at least one second portion 15 includes a plurality of second yarns 151, and the plurality of first yarns 141 are interlaced with one another to form the plurality of first through holes 12. Preferably, the at least one first portion 14 defines at least one hollow portion 16, and the plurality of second yarns 151 are windingly disposed through the plurality of first yarns 141 and extend through the at least one hollow portion 16. The at least one film layer 20 partially covers the at least one hollow portion 16.

In this embodiment, the main body 10 includes two said first portions 14 and one said second portion 15, and the two said first portions 14 are spaced apart from each other and define one said hollow portion 16 therebetween. The plurality of second yarns 151 are interlaced with one another in the hollow portion 16 to form the plurality of second through holes 13. Therefore, a portion of the hollow portion 16 without the at least one film layer 20 maintains its original elasticity, and a portion of the hollow portion 16 with the at least one film layer 20 is not easily deformed when being stretched and has good structural stability. Preferably, an elasticity of each of the plurality of second yarns 151 is larger than an elasticity of each of the plurality of first yarns 141 so that the second portion 15 can be stretched in a larger degree. A diameter of each of the plurality of second yarns 151 is larger than a diameter of each of the plurality of first yarns 141, which allows the two surfaces 11 of the main body 10 to have obvious concave and convex structures so that the at least one film layer 20 disposed thereon provides good three-dimensional effect. As viewed in an axial direction of one of the plurality of second yarns 151, the at least one film layer 20 adheringly covers at least ⅓ of a circumferential surface of said second yarn 151, which prevents the plurality of second yarns 151 from deformation and becoming unraveled when being cut.

The textile fabric 1 preferably further includes at least one reinforcement layer 30, and the at least one reinforcement layer 30 is at least partially overlapped and disposed on the at least one film layer 20 so as to locally enhance the wear resistance of the textile fabric 1. For example, the textile fabric 1 may be used as a vamp of a shoe, and the second portion 15 and the hollow portion 16 are overlapped with a tongue of the shoe. A shape of the at least one film layer 20 corresponds to shapes of the vamp and the hollow portion 16 and extends in a U shape, and the at least one reinforcement layer 30 extends in a U shape and is located on the vamp near a toecap. Therefore, the plurality of second yarns 151 extending through the hollow portion 16 are elastically stretchable and pull the two said first portions 14 inwardly, which is convenient for wearing the shoe and provides good covering effect, and the at least one reinforcement layer 30 provides wear resistance effect. In this embodiment, a material of the at least one reinforcement layer 30 is identical to a material of the at least one film layer 20 for easy combination. In other embodiments, the material of the at least one reinforcement layer may be different from the material of the at least one film layer, for example, the at least one reinforcement layer may be made of rubber; colors of the at least one reinforcement layer and the at least one film layer may be identical with or different from each other.

In summary, the at least one film layer 20 can partially cover the plurality of first through holes 12 and the plurality of second through holes 13 to achieve waterproof and anti-slip effects, and structures of the two first portion 14 can also be restricted so that the textile fabric 1 has good tensile strength and sufficient flexibility. In addition, a color of the at least one film layer 20 is changeable and matched with a color of the main body 10 to create diverse visual effects, and the at least one film layer 20 shows a three-dimensional surface texture corresponding to the main body 10, resulting in a special visual effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A textile fabric, including:
a main body, including two surfaces opposite to each other, each of the two surfaces having a surface texture being concave and convex; and
at least one film layer, partially disposed on one of the two surfaces and being concave and convex corresponding to the surface texture.

2. The textile fabric of claim 1, wherein the at least one film layer is made of a material including at least one of polyurethane and polyvinyl chloride.

3. The textile fabric of claim 1, wherein each of the at least one film layer includes a film material layer and a connecting layer, the connecting layer is disposed on a side of the film material layer and connected with one of the two surfaces, and a thickness of the connecting layer is smaller than or equal to a thickness of the film material layer.

4. The textile fabric of claim 1, wherein a thickness of each of the at least one film layer is between 20 μm and 450 μm.

5. The textile fabric of claim 1, wherein the main body includes a plurality of first through holes and a plurality of second through holes, a diametrical dimension of each of the plurality of second through holes is larger than a diametrical dimension of each of the plurality of first through holes, and the at least one film layer covers a portion of the plurality of first through holes and a portion of the plurality of second through holes.

6. The textile fabric of claim 1, further including at least one reinforcement layer, wherein the at least one reinforcement layer is at least partially overlapped and disposed on the at least one film layer.

7. The textile fabric of claim 1, wherein the main body further includes at least one first portion and at least one second portion, each of the at least one second portion is connected with the at least one first portion; when being stretched by the same force, an amount of deformation of the at least one first portion is smaller than an amount of deformation of the at least one second portion.

8. The textile fabric of claim 7, wherein the at least one first portion includes a plurality of first yarns, the at least one second portion includes a plurality of second yarns, and an elasticity of each of the plurality of second yarns is larger than an elasticity of each of the plurality of first yarns.

9. The textile fabric of claim 7, wherein the at least one first portion defines at least one hollow portion, the at least one first portion includes a plurality of first yarns, the at least one second portion includes a plurality of second yarns, the plurality of second yarns are windingly disposed through the plurality of first yarns and extend through the at least one hollow portion, and the at least one film layer partially covers the at least one hollow portion.

10. The textile fabric of claim 5, wherein the at least one film layer is made of a material including polyurethane and is a waterproof breathable membrane; each of the at least one film layer includes a film material layer and a connecting layer, the connecting layer is disposed on a side of the film material layer and connected with one of the two surfaces, and a thickness of the connecting layer is smaller than or equal to a thickness of the film material layer; a material of the connecting layer is different from a material of the film material layer; a thickness of each of the at least one film layer is between 50 μm and 400 μm; the at least one film layer is coveringly disposed on one of the two surfaces and exposed outward from the other of the two surfaces; the textile fabric further includes at least one reinforcement layer, the at least one reinforcement layer is at least partially overlapped and disposed on the at least one film layer; a material of the at least one reinforcement layer is identical to a material of the at least one film layer; the diametrical dimension of each of the plurality of first through holes is smaller than or equal to 2 mm, the diametrical dimension of each of the plurality of second through holes is larger than or equal to 5 mm; the main body further includes two first portions and a second portion, the second portion is connected between the two first portions; when being stretched by the same force, an amount of deformation of each of the two first portions is smaller than an amount of deformation of the second portion; each of the two first portions includes a plurality of first yarns, the second portion includes a plurality of second yarns, a diameter of each of the plurality of second yarns is larger than a diameter of each of the plurality of first yarns; an elasticity of each of the plurality of second yarns is larger than an elasticity of each of the plurality of first yarns; the plurality of first yarns are interlaced with one another to form the plurality of first through holes, the two first portions are spaced apart from each other and define a hollow portion therebetween, the plurality of second yarns are windingly disposed through the plurality of first yarns and extend through the hollow portion, the at least one film layer partially covers the hollow portion; the plurality of second yarns are interlaced with one another in the hollow portion to form the plurality of second through holes; and as viewed in an axial direction of one of the plurality of second yarns, the at least one film layer adheringly covers at least ⅓ of a circumferential surface of said second yarn.
